(19) United States
(12) Patent Application Publication
(10) Pub. No.: US 2010/0083288 A1
(43) Pub. Date: Apr. 1, 2010

(54) METHOD AND SYSTEM FOR APPLICATION PROGRAM MANAGEMENT PLATFORM

(75) Inventors: Rainer Lichtenfeld, San Marcos, CA (US); Joshua Blatt, Palo Alto, CA (US); Krishnan Anantheswaran, San Jose, CA (US); Muhammad M. Rahman, San Diego, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: YAHOO! INC., Sunnyvale, CA (US)

(21) Appl. No.: 12/242,459

(22) Filed: Sep. 30, 2008

(51) Int. Cl. G06F 9/46

(52) U.S. Cl. 719/328

(57) ABSTRACT

Methods and systems are provided that may be used to provide flexibility to a program developer so that certain values used in an application program need not be hard coded directly into the application program's code. An exemplary method may include defining at least one identifier of at least one source of information and a sequence in which the at least one source of information is to be read by an application program. At least one status file may be created to associate the at least one identifier with at least one value and at least one source. A property reader may be created to read the information from the at least one source of information according to the sequence and the at least one value associated with the at least one identifier.

### BACKGROUND

1. Field

The subject matter disclosed herein relates to application program management.

2. Information

Application programs are continually developed for use via the Internet and other types of networks. Such application programs are often complex and may utilize several different critical types of information. For example, an application program may require a user to enter a password in order to access a particular website or file, or to be provided with certain functionalities. Accordingly, the application program may load the password information for comparison with a password entered by a user.

Unfortunately, a problem may arise if a user's password is changed or a new password with certain privileges is added. In some systems, password information is hard coded. Accordingly, if a password is changed or a new password is added, a program developer typically manually changes the password information in the application program itself, and then the entire application program code may have to be recompiled. This process may result in certain delays as an application program which is being executed has to be stopped, the application program's code has to be edited, and then the application program has to be recompiled. Accordingly, hard coding such password or certain other types of critical information within an application program itself may result in certain programming inefficiencies.

Files and other tools may be added to an application program while the program is being compiled. These files and/or tools may be acquired from pre-defined locations, such as specific file servers, in a pre-defined order. Moreover, a set number of such files and/or tools may be added every time an application program is being compiled. Such an arrangement may be problematic in scenarios where accessing files and/or tools in a different sequence may be preferred or when additional or few files and/or tools may be required during the compiling process.

An application program that loads files and/or tools while being compiled may be difficult to debug in the event that an error occurs during execution of the application program. For example, it may necessary for a programmer to check each of the different files and/or tools that was loaded during the compiling process in order to locate the source of the error.

Accordingly, a programming platform which allows a programmer to change critical information and debug a program in an efficient manner is therefore desirable.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 illustrates a diagram of a system for implementing an application program management platform according to one implementation.

FIG. 2 illustrates a process for utilizing a key to locate a value external to an application program according to one particular aspect.

FIG. 3 illustrates a process for determining values corresponding to keys in an application program according to one particular aspect.

FIG. 4 illustrates a process for implementing an application program according to one aspect.

FIG. 5 is a schematic diagram illustrating a computing environment system that may include one or more devices configurable to compile and execute an application program which utilizes key-value pairs according to one aspect.

### DETAILED DESCRIPTION

In the following detailed description, numerous specific details are set forth to provide a thorough understanding of the claimed subject matter. However, it will be understood by those skilled in the art that the claimed subject matter may be practiced without these specific details. In other instances, well-known methods, procedures, components and/or circuits have not been described in detail so as not to obscure the claimed subject matter.

Some portions of the detailed description which follow are presented in terms of algorithms and/or symbolic representations of operations on data bits or binary digital signals stored within a computing system memory, such as a computer memory. These algorithmic descriptions and/or representations are the techniques used by those of ordinary skill in the data processing arts to convey the substance of their work to others skilled in the art. An algorithm is here, and generally, considered to be a self-consistent sequence of operations and/or similar processing leading to a desired result. The operations and/or processing involve physical manipulations of physical quantities. Typically, although not necessarily, these quantities may take the form of electrical and/or magnetic signals capable of being stored, transferred, combined, compared and/or otherwise manipulated. It has proven convenient at times, principally for reasons of common usage, to refer to these signals as bits, data, values, elements, symbols, characters, terms, numbers, numerals and/or the like. It should be understood, however, that all of these and similar terms are to be associated with the appropriate physical quantities and are merely convenient labels. Unless specifically stated otherwise, as apparent from the following discussion, it is appreciated that throughout this specification discussions utilizing terms such as “processing”, “computing”, “calculating”, “associating”, “identifying”, “determining” and/or the like refer to the actions and/or processes of a computing platform, such as a computer or a similar electronic computing device, that manipulates and/or transforms data represented as physical electronic and/or magnetic quantities within the computing platform's memories, registers, and/or other information storage, transmission, and/or display devices.

Some exemplary methods and systems are described herein that may be used to provide an application program management platform. In one particular implementation, a program developer creates an application program that utilizes various tools and files located on an accessible network. When it comes time to compile such an application program, the program developer may utilize a command line prompt to specify files and/or tools to be accessed during compiling. The program developer may also specify a sequence in which such files and/or tools are to be accessed during compilation and a memory location or hierarchy of memory locations in which to locate such files and/or tools. An application program module may compile such an application program.

Such an application program may contain certain keys, e.g., references to certain values used by the application program. Such values, however, may not be hard-coded into the application program itself. For example, instead of hard coding certain passwords directly into an application program, a program developer may instead include a key, or reference, to the value itself. During execution of such an application program, a value corresponding to each such key may be determined from certain files and/or databases, for example. A user may subsequently change a value associated with the key after the application program has been compiled and is currently being executed. In one implementation, an administrative component may periodically check values associated with certain keys in files and/or databases to determine whether they have been updated, e.g., by a user. In the event that any of such values have been updated, such an administrative component may update the values in a status file accessible by the application program during execution of the application program. In an alternative implementation, a program developer may enter new values into a form on a particular website, and the administrative tool may utilize such new values to update the values in a status file accessible by the application program during execution of the application program.

If associated values are determined for keys, such keys, associated values, and a data storage location, such as a physical location or some other addressable location, where such values were physically stored may be stored in a status file accessible by the application program. Such a status file may be useful in the event that an error occurs and the application program has to be debugged. For example, instead of requiring a program developer to manually visit each separate file and/or database in which the value associated with each key is located, a software developer may instead view a status file to determine which values may be faulty.

An application program management platform may be utilized, for example, by a program developer creating an advertising application program for displaying advertising on a website. Such an application program management platform may assist a programmer of Java-based application programs. Such an application program management platform may allow a software developer to update certain program values while an application program is being executed. Such an application program management platform may also provide a software developer with additional flexibility in specifying files and/or tools to be accessed, as well as a sequence in which to access and where to search for such files and/or tools.

“Key-value pair,” as used herein may refer to an association between a key and a value. For example, such a key may be included within an application program and such a value may be stored in a file or in a database that is separate from such an application program. Accordingly, such a value may be altered without having to hard code such a change into an application program itself. For example, a key such as “DB.User.Name” may be located within an application program and a file accessible by the application program may indicate that “DB.User.Name” is “57star.” Therefore, instead of hard coding the password “57star” directly into the application program itself, a program developer may instead program the key “DB.User.Name” into the application program. Such a password may be subsequently changed without having to recompile the application program.

“Property reader,” as used herein may refer to a software module for accessing a file or database, for example, to determine a value corresponding to a particular key. Upon retrieving a corresponding value, a key, corresponding value, and location where the corresponding value was located may be stored in a status file accessible by an application program.

“Properties Manager,” as used herein may refer to a module to controlling one or more property readers. Property readers may be created as needed by a Properties Manager. Such a Properties Manager may have access to a status file in which values corresponding to keys are stored. A status file may be created and updated by a Properties Manager whenever a reader reads values. Such a status file may contain all defined key value pairs across all readers. Upon execution of an application program, a Properties Manager may access the status file whenever a key in the application program code is encountered, to determine its corresponding value.

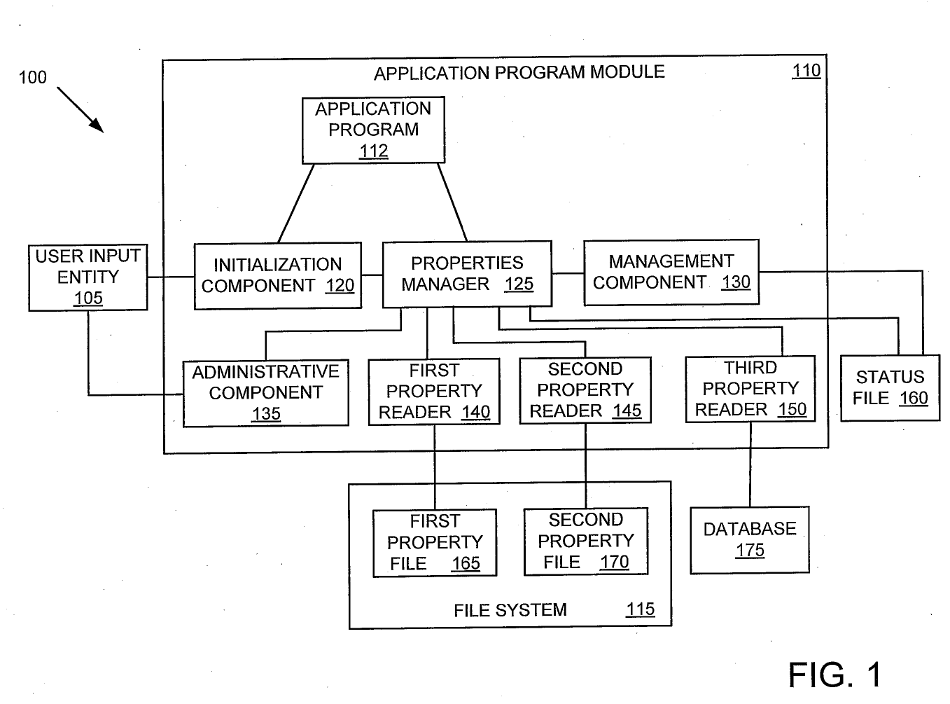

FIG. 1 illustrates a diagram of a system 100 for implementing an application program management platform according to one implementation. Such a system 100 may include various entities such as a user input entity 105, an application program module 110, and a file system 115, just to name a few. Such a user input entity 105 may comprise a computer or user terminal at which a software developer may provide an input to compile or execute an application program 112. A software developer may provide an input via user input entity 105, for example. Application program module 110 may compile an application program 112. Such an application program 112 may require that certain files or tools be accessed during a compiling process. A software developer may enter names of such files and locations, or a hierarchy of locations, and a sequence in which such files are to be accessed. After an application program has been compiled, a software tool may be used to deploy compiled application and configuration information and all dependencies on a server.

An application program module 110 may include several entities, such as an initialization component 120, a Properties Manager 125, a management component 130, and an administrative component 135, to name just a few examples. Initialization component 120 may determine, based on information provided by the user input 105, which property readers need to be created to read keys from files and/or databases. Initialization component 120 may also create property readers, such as a first property reader 140, a second property reader 145, and a third property reader 150. Although three property readers are shown in FIG. 1, it should be appreciated that more or fewer than three property readers may be utilized in other implementations. Moreover, in some implementations, the Properties Manager 125 itself may create property readers, instead of initialization component 120. Properties Manager 125 may control operation of first, second, and third property readers 140, 145, and 150, respectively. For example, Properties Manager 125 may instruct a property reader to access a particular file at a particular time to determine a value corresponding to a key. Upon retrieving values corresponding to keys, such values, keys, and locations where such values were located may be stored in a status file 160. Status file 160 may be stored within application module 110 or in some other location accessible by Properties Manager 125. Storage within status file 160 of values, keys, and locations where such values were located may be beneficial in the event that such an application program 112 experiences an error during execution, as a program developer may view contents of status file 160 and readily determine which value, for example, is faulty.

In one particular implementation, each property reader may be adapted to access a property file or database to match a key with a corresponding value. A property file may contain one or more key-value pairs. In the example shown in FIG. 1, first property reader 140 is adapted to determine a value stored within a first property file 165. First property file 165 may be stored, for example, within file system 165. If Properties Manager 125 instructs first property reader 140 to acquire a value from first property file 165, it may provide a key to first property reader 140, and first property reader 140 may, in turn, “read” first property file 165. Reading first property file 165 may comprise searching for the key within first property file 165 to determine a value corresponding to the key. Upon determining a corresponding value, such a value is provided to Properties Manager 125 which may store the key, corresponding value, and a location where the value was located which in this example, is first property file 165 of file system 115.

In one particular implementation, a location where first property file 165 is stored may not be known. In such an implementation, first property reader 140 may have to search for first property file 165 in several places before it is found. For example, first property reader 140 might initially search for first property file 165 in file system 115. In the event that first property file 165 is not located in file system 115, first property reader 140 may search a second location for first property file 165. Accordingly, a hierarchy of locations may be searched until first property file 165 is location. A program developer may provide such a hierarchy of locations via user input 105 prior to compilation of such an application program 112.

Second property reader 145 may match a second key in second property file 170 to locate a corresponding value. As with first property reader 140, such a second key, corresponding value, and a location of second property file 170 may be provided to Properties Manager 125 and then stored in status file 160. Third property reader 150 may access a database 175 external to file system 115 to match a third key with a corresponding value. Although only property files within a file system 115 and database 175 are shown in FIG. 1 as being locations where a key and corresponding values are stored, it should be appreciated that there may be other entities in which keys and corresponding values may be stored such as, for example, servers or Directory Services such as like Lightweight Directory Access Protocol (“LDAP”), to name just a couple examples. LDAP may be used to store user authentication and authorization information, for example.

Application program module 110 may also include management component 130 and administrative component 135. Management component 130 may be adapted to consolidate keys, corresponding values, and locations where such values were located, with status file 160.

A user may subsequently change a value associated with a key after an application program 112 has been compiled and is currently being executed. In one implementation, administrative component 135 may periodically check values associated with certain keys in files and/or databases to determine whether they have been updated. In the event that any of such values have been updated, such an administrative component 135 may update the values in a status file 160 utilized by such an application program 112 during execution of the application program 112. In an alternative implementation, a program developer may enter new values into a form on a particular website, and administrative tool 135 may utilize such new values to update the values in such a file utilized by an application program 112 during execution of the application program 112.

Although Properties Manager 125, administrative component 135, and management component 130 are illustrated as being separate entities, it should be appreciated that in one particular implementation, functions performed by administrative component 135 and management component 130 may be performed directly by Properties Manager 125, in which case an administrative component 135 and a management component 130 separate from Properties Manager 125 may not be needed.

In one particular implementation, specific values are associated with a specified environment. One such environment may be a production environment in which key-value pairs corresponding to such a production environment are utilized by an application program 112. Another such environment may be a quality assurance (QA) environment in which key-value pairs corresponding to such a QA environment are utilized by an application program 112. Additional examples of environments include, for example, development, integration, and staging environments.

In an implementation in which different environments may be utilized, a separate status file may be utilized to store key-value pair information corresponding to a particular environment. For example, in a production environment, keys, corresponding values, and locations where such values were located may be stored in a production environment status file. On the other hand, in a QA environment, keys, corresponding values, and locations where such values were located may be stored in a QA environment status file.

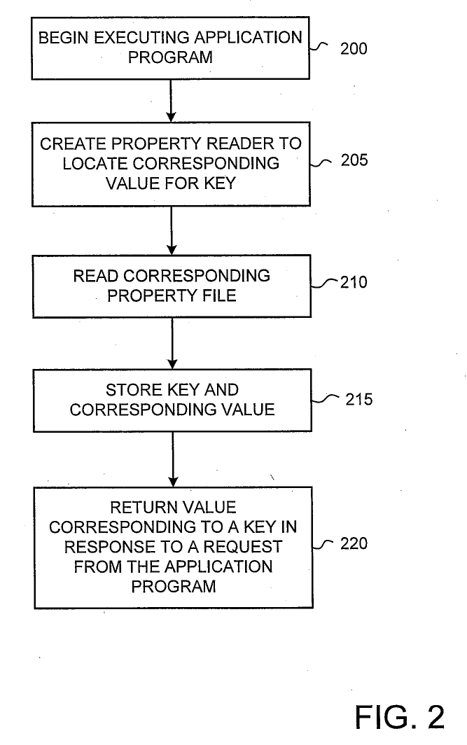

FIG. 2 illustrates a process for utilizing a key to locate a value external to an application program according to one particular aspect. First, execution of an application program is begun at operation 200. Next, a property reader is created at operation 205 to locate a corresponding value for a key for such an application program. A property reader may comprise a module adapted to match a particular key with a value stored in an addressable memory location, such as in a file or on database. As discussed above, such a property reader may be created by a Properties Manager of an application program module. A Properties Manager may comprise a module adapted to create and/or control one or more property readers. At operation 210, a property reader locates and then reads a corresponding property file in which the key a corresponding value are stored. Finally, at operation 215, the key and corresponding value are stored within the Properties Manager and in a file accessible to the Properties Manager. Such a key, corresponding value, and a location where the key and corresponding value were located may also be stored in a status file. Finally, at operation 220, a value corresponding to a key may be returned by the Properties Manager to the application program in response to a request from the application program. Although the process depicted in FIG. 2 illustrates use of only one key, it should be appreciated that an application program may utilize more than one key in some implementations.

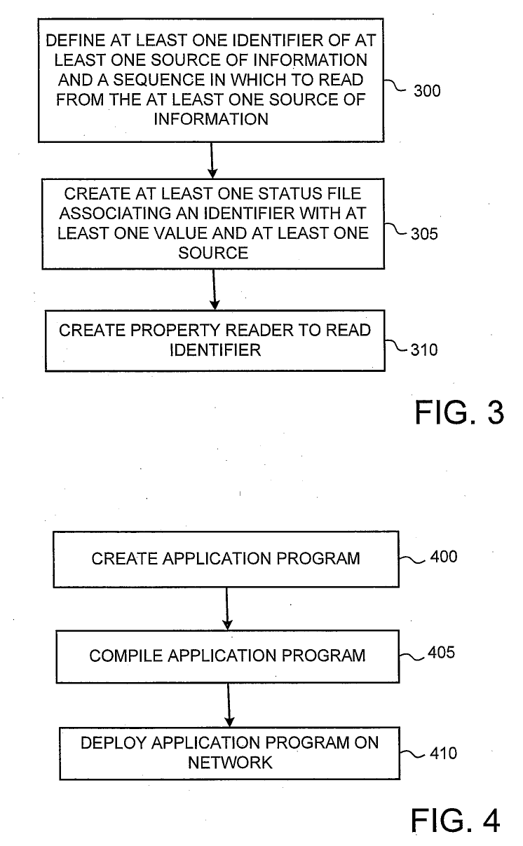

FIG. 3 illustrates a process for determining values corresponding to keys in an application program according to one particular aspect. First, at operation 300, at least key or one identifier of at least one source of information and a sequence in which the at least one source of information is to be read by an application are defined. A software developer may input such information via user input 105 shown in FIG. 1. Next, at operation 305, at least one status file associating the at least key with at least one value and at least one source is created. Finally, at operation 310, a property reader is created to read the information from the at least one source of information according to the sequence and the at least one value associated with the key.

FIG. 4 illustrates a process for implementing an application program according to one aspect. First, at operation 400, a software developer creates an application program. Such an application program may include a number of keys to which corresponding values may be stored in property files, for example, external to the application program itself such as those discussed above with respect to FIG. 1. Next, such an application program may be compiled at operation 405. During such compiling, corresponding values for any keys in the application program code may be located and stored in a status file. Finally, at operation 410, the application program may be deployed on a network, such as the Internet. During deployment, portions, or all, of an application may be stored on various servers or other entities dispersed throughout the network. A configuration tool may be accessed to manage such deployment. Such a configuration tool may determine which servers, tools, and program code are required in order to deploy such an application program. Such a configuration tool may, for example, instruct servers regarding which software packages are to be installed and then saves such software packages onto such servers.

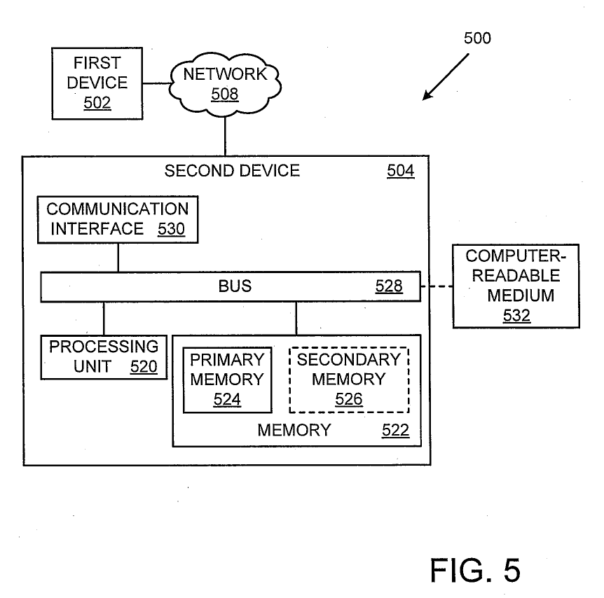

FIG. 5 is a schematic diagram illustrating a computing environment system 500 that may include one or more devices configurable to compile and execute an application program which utilizes key-value pairs using one or more techniques illustrated above, for example, according to one implementation. System 500 may include, for example, a first device 502 and a second device 504, which may be operatively coupled together through a network 508.

First device 502 and second device 504, as shown in FIG. 5, may be representative of any device, appliance or machine that may be configurable to exchange data over network 508. First device 502 may be adapted to receive a user input from a program developer, for example. By way of example but not limitation, either of first device 502 or second device 504 may include: one or more computing devices and/or platforms, such as, e.g., a desktop computer, a laptop computer, a workstation, a server device, or the like; one or more personal computing or communication devices or appliances, such as, e.g., a personal digital assistant, mobile communication device, or the like; a computing system and/or associated service provider capability, such as, e.g., a database or data storage service provider/system, a network service provider/system, an Internet or intranet service provider/system, a portal and/or search engine service provider/system, a wireless communication service provider/system; and/or any combination thereof.

Similarly, network 508, as shown in FIG. 5, is representative of one or more communication links, processes, and/or resources configurable to support the exchange of data between first device 502 and second device 504. By way of example but not limitation, network 508 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

As illustrated, for example, by the dashed lined box illustrated as being partially obscured of first device 502, there may be additional like devices operatively coupled to network 508.

It is recognized that all or part of the various devices and networks shown in system 500, and the processes and methods as further described herein, may be implemented using or otherwise include hardware, firmware, software, or any combination thereof.

Thus, by way of example but not limitation, second device 504 may include at least one processing unit 520 that is operatively coupled to a memory 522 through a bus 528.

Processing unit 520 is representative of one or more circuits configurable to perform at least a portion of a data computing procedure or process. By way of example but not limitation, processing unit 520 may include one or more processors, controllers, microprocessors, microcontrollers, application specific integrated circuits, digital signal processors, programmable logic devices, field programmable gate arrays, and the like, or any combination thereof.

Memory 522 is representative of any data storage mechanism. Memory 522 may include, for example, a primary memory 524 and/or a secondary memory 526. Primary memory 524 may include, for example, a random access memory, read only memory, etc. While illustrated in this example as being separate from processing unit 520, it should be understood that all or part of primary memory 524 may be provided within or otherwise co-located/coupled with processing unit 520.

Secondary memory 526 may include, for example, the same or similar type of memory as primary memory and/or one or more data storage devices or systems, such as, for example, a disk drive, an optical disc drive, a tape drive, a solid state memory drive, etc. In certain implementations, secondary memory 526 may be operatively receptive of, or otherwise configurable to couple to, a computer-readable medium 532. Computer-readable medium 532 may include, for example, any medium that can carry and/or make accessible data, code and/or instructions for one or more of the devices in system 500.

Second device 504 may include, for example, a communication interface 530 that provides for or otherwise supports the operative coupling of second device 504 to at least network 508. By way of example but not limitation, communication interface 530 may include a network interface device or card, a modem, a router, a switch, a transceiver, and the like.

System 500 may be adapted to allow a program developer to input certain information via first device 502, such specific files and/or tools to be accessed during compiling. The program developer may also specify a sequence in which such files and/or tools are to be accessed during compilation and a memory location or hierarchy of memory locations in which to locate such files and/or tools.

System 500 may utilize second device 504 to implement an application program module and determine corresponding values for certain keys stored in application program code.

An application program management platform, as discussed herein, provides flexibility to a software developer because certain values need not be stored directly within an application program's code. Instead, a key may be stored in such code and a Properties Manager may determine a corresponding value by instructing a property reader to determine such a corresponding value by accessing or reading an associated property file, for example. In the event that a value corresponding to such a key is changed, an administrative component may determine that such an update has occurred and may change a corresponding value stored in a status file. Accordingly, an application program may have access to such an updated value without requiring a software developer to halt execution of an application program and recompiling such an application program.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

What is claimed is:

1. A method, comprising:
defining at least one identifier of at least one source of information and a sequence in which the at least one source of information is to be read by an application program module;
creating at least one status file associating the at least one identifier with at least one value and at least one source; and
creating a property reader to read the information from the at least one source of information according to the sequence and the at least one value associated with the at least one identifier.

2. The method of claim 1, the defining being performed by a user input provided by a user input entity.

3. The method of claim 2, the defining being performed at a command line prompt by the user.

4. The method of claim 1, wherein the defining further comprises identifying at least one location in which to search for the at least one source of information.

5. The method of claim 4, wherein the identifying at least one location comprises identifying a hierarchy of locations in which to search for the at least one source of information.

6. The method of claim 1, further comprising executing the application program, wherein the application program is adapted to instruct the property reader to read the information from the at least one source of information.

7. The method of claim 1, further comprising determining, at predetermined intervals, whether the information read from the at least one source of information has been updated.

8. An article comprising:
a storage medium comprising machine-readable instructions stored thereon which, if executed by a computing platform, are adapted to enable the computing platform to:
receive at least one identifier of at least one source of information and a sequence in which the at least one source of information is to be read by an application program module;
create at least one status file associating the at least one identifier with at least one value and at least one source; and
create a property reader to read the information from the at least one source of information according to the sequence and the at least one value associated with the at least one identifier.

9. The article of claim 8, wherein the machine-readable instructions are further adapted to enable the computing platform to receive, from a user input entity, the at least one identifier of at least one source of information and the sequence in which the at least one source of information is to be read by the application program.

10. The article of claim 8, wherein the machine-readable instructions are further adapted to enable the computing platform to receive an identity of at least one location in which to search for the at least one source of information.

11. The article of claim 8, wherein the machine-readable instructions are further adapted to enable the computing platform to receive an identity of a hierarchy of locations in which to search for the at least one source of information.

12. The article of claim 8, wherein the machine-readable instructions are further adapted to enable the computing platform to execute the application program, wherein the application program is adapted to instruct the property reader to read the information from the at least one source of information.

13. The article of claim 8, wherein the machine-readable instructions are further adapted to enable the computing platform to determine, at predetermined intervals, whether the information read from the at least one sources of information has been updated.

14. A system comprising:
a computing platform adapted to:
receive at least one identifier of at least one source of information and a sequence in which the at least one source of information is to be read by an application program module;
create at least one status file associating the at least one identifier with at least one value and at least one source; and
create a property reader to read the information from the at least one source of information according to the sequence and the at least one value associated with the at least one identifier.

15. The system of claim 14, wherein the computing platform is further adapted to receive, from a user input entity, the at least one identifier of at least one source of information and the sequence in which the at least one source of information is to be read by the application program.

16. The system of claim 14, wherein the computing platform is further adapted to enable the computing platform to receive an identity of at least one location in which to search for the at least one source of information.

17. The system of claim 14, wherein the computing platform is further adapted to enable the computing platform to receive an identity of a hierarchy of locations in which to search for the at least one source of information.

18. The system of claim 14, wherein the computing platform is further adapted to enable the computing platform to execute the application program, wherein the application program is adapted to instruct the property reader to read the information from the at least one source of information.

19. The system of claim 14, wherein the computing platform is further adapted to enable the computing platform to determine, at predetermined intervals, whether the information read from the at least one source of information has been updated.
